(19) United States
(12) Patent Application Publication
(10) Pub. No.: US 2015/0135714 A1
(43) Pub. Date: May 21, 2015

(54) PRESSURE POWER UNIT

(71) Applicants: Bruce I. Benn, Ottawa (CA); Jean-Pierre Hofman, Frejus (FR)

(72) Inventors: Bruce I. Benn, Ottawa (CA); Jean-Pierre Hofman, Frejus (FR)

(21) Appl. No.: 14/403,348

(22) PCT Filed: May 24, 2013
(86) PCT No.: PCT/IB2013/001285

§ 371 Date: Nov. 24, 2014

(30) Foreign Application Priority Data
May 24, 2012 (CA) 2778101

(51) Int. Cl. F01K 25/08

(52) U.S. Cl. CPC F01K 25/08
USPC 60/671

(57) ABSTRACT

The invention relates to energy conversion and generation systems, and more specifically, to a unit for generating and converting energy by way of a pressure differential in a Working Fluid. A Pressure Power Unit is described which comprises a condenser and a vaporizer arranged in a closed loop, the condenser and vaporizer being respectively maintained at lower and higher temperatures relative to one another. A Working Fluid is circulated through the closed loop, the Working Fluid having different equilibrium vapor pressures in the condenser and in the vaporizer, according to the respective state functions, representing two different levels of elastic potential energy. This results in a pressure differential between the condenser and the vaporizer. A work extraction system is positioned between the outlet of the vaporizer and the inlet of the condenser, to convert the elastic potential energy/pressure differential into kinetic energy. Other embodiments of the invention are also described.

### FIELD OF INVENTION

The present invention relates to energy conversion and generation systems, and more specifically, to a unit for generating and converting energy by way of a pressure differential in a working fluid.

### BACKGROUND OF THE INVENTION

Despite efforts to the contrary, mankind continues to consume more and more energy globally. As a result of concerns about global warming, pollution, diminishing availability of fossil fuels and the high cost of energy in general, efforts are being made to provide clean, renewable and less expensive sources of energy, and ways of converting energy.

Although some sources of clean energy are available, such as wind and solar power, there are other sources of energy that are still largely unexploited, such as waste heat. For example, many power generation systems use steam turbines without extracting valuable energy in the waste steam.

As well, many of the known power generation systems are only practical and efficient if they are built to a very large scale.

There is therefore a need for an improved unit for generating and converting energy that is clean, cost effective, efficient, and can be deployed in various sizes, including small systems.

### SUMMARY OF THE INVENTION

It is an object of the invention to provide an improved unit for generating and converting energy.

This document describes a Power Unit (referred to hereunder as the “Pressure Power Unit”), based on the system of “Power Generation by Pressure Differential” (the “Pressure Power System”, described in the co-pending patent application Serial Number PCT/CA2013/xxxxx), where different state functions⁽¹⁾ in a “Vapor Recovery Unit” (i.e. the “cold sub-system”) versus a “Heat Recovery Unit” (i.e. the “warm sub-system”), enable the exploitation of the properties of a Working Fluid, made of a compound substance, often organic, characterized by a low Normal Boiling Point (N.B.P.) This is done by creating a pressure differential between the two sub-systems which enables extraction of work (i.e. power production) within a “Work Extractor Unit”.
Pressure Power System's pattern
As shown in FIG. 1, the Pressure Power System 100 generally comprises a cycle where the Working Fluid circulates in a closed loop between a cold sub-system 105 and a warm sub-system 110, where the Working Fluid is stored separately and is respectively maintained at lower and higher Ambient Temperatures. Such configuration causes the Working Fluid to present different equilibrium vapor pressure⁽²⁾ in each sub-system 105, 110, which makes its gaseous form represent different elastic potential energy levels, thereby causing a pressure differential between the two sub-systems 105, 110, which may be exploited to extract work.
Pressure Power Unit's path
A block diagram of an exemplary Pressure Power Unit 200 is shown in FIG. 2, comprising a cycle where the Working Fluid circulates in a closed loop between a Vapor Recovery Unit 205 (i.e. the cold sub-system 105), where the Working Fluid is liquefied, and the Heat Recovery Unit 210 (i.e. the warm sub-system) where the liquid is vaporized, which respectively maintains the Working Fluid at lower and higher Ambient Temperatures. Such a flow scheme causes the state function of the system to be different in the components of the cold sub-system 105 and warm sub-system 110 devices: the properties of the substance vary and result in different levels of elastic potential energy of the Working Fluid (i.e. in different Ambient Pressures), which corresponds to a pressure differential enabling a Work Extractor Unit 215 in the closed loop, to produce power.

Accordingly, the “Pressure Power Unit” 200, targets principally the production of power by way of extraction of work, which can be, but is not limited to being, an industrial facility such as a power station enabling the generation of electricity. Therefore, the structural design of such Pressure Power Unit 200 comprises mainly three specific parts respectively performing:
The harnessing and/or recovery of the thermal energy found in the surrounding environment of the “Heat Recovery Unit” 210 (i.e. the surrounding temperature⁽⁵⁾), and its transformation into elastic potential energy of a Working Fluid (by vaporization of the liquid substance) stored at a specific equilibrium vapor pressure in this warm sub-system 110, according to the Ambient Temperature which results from the surrounding temperature.
The production of power in the “Work Extractor Unit” 215, which exploits, between the warm sub-system 110 and the cold sub-system 105, the pressure differential resulting from the different equilibrium vapor pressure of the Working Fluid as met in said sub-systems 105, 110. The kinetic energy extracted by the Work Extractor Unit 215 may be converted, for example, to electrical energy via an electric generator or alternator 220.
The recovery of the Working Fluid in its vaporous form into the “Vapor Recovery Unit” 205, where a lower Ambient Temperature results in a different equilibrium vapor pressure in this cold sub-system 105, which corresponds to a lower Ambient Pressure and enables the re-liquefaction of the Working Fluid.

A number of ways for manufacturing these three parts will become apparent to anyone with skill in the art and may result in different structural frameworks or embodiments, which enables developing this technology without departing from the fundamental concept of this invention.

### Design

The exemplary Pressure Power Unit 300 shown in FIG. 3 comprises several specially designed components principally comprised of:
A) The “Heat Recovery Unit” 310 (i.e. the warm sub-system 110), which consists of a pressure vessel enabling the storage of the Working Fluid and functioning as a heat exchanger which warms the Working Fluid by heat transfer fluids (e.g. the ambient atmosphere, vapors and/or liquids) and causes part of the liquid Working Fluid to vaporize and transform the surrounding thermal energy into elastic potential energy within said vapor.
   Therefore, the Heat Recovery Unit is comprised of:
(i) Ambient Heat Collectors 325:
   Generally made of a series of heat exchangers, the Ambient Heat Collectors 325 circulate a heat transfer fluid used in the Heat Recovery Unit 310 to enable a heat exchange between said heat transfer fluid and the surrounding temperature⁽⁵⁾ resulting either directly from the surrounding area or room temperature, from the exploitation of external thermal energy sources or both (in which case the Pressure Power Unit 300 becomes a hybrid unit). Preferably, the Ambient Heat Collectors 325 are dimensioned to maintain the heat transfer fluid at an Ambient Temperature near or a little above the ISCM⁽⁶⁾. Air blowers 330 may also be used to increase the flow of Ambient air across the Ambient Heat Collectors 325.
(ii) A Pre-Heater 335:
   In case the surrounding temperature is not constant and may cause a period of functioning where the Ambient Temperature of the Working Fluid in a Vaporizer 340 would not be sufficient to produce the required volume of pressurized vapor (i.e. Ambient Pressure), a complementary heat collector may be used (possibly using a gas burner 345 to provide additional heat energy) to pre-heat the heat transfer fluid.
(iii) A Vaporizer 340:
   The storage container where the Working Fluid is stored in the warm sub-system 110, is exploited not only as a heat exchanger which uses the above heat transfer fluid to maintain its Ambient Temperature close to the ISCM, but also as a vaporizer device⁽⁷⁾ which enables the Working Fluid to change phase⁽¹⁰⁾ and transform from liquid to pressurized vapor, thereby converting the external thermal energy into internal energy (a part of which being made of elastic potential energy causing an increase of pressure which results in a pressure differential with the cold sub-system 105).
   However, one should note that, when available, an external source of heat also may be used as the heat transfer fluid to warm the Working Fluid directly or indirectly, and to maintain it in the Vaporizer 340 at an Ambient Temperature near or a little above the ISCM, in which case the Ambient Heat Collectors 325 and/or the Pre-Heater 335 could be removed from the Heat Recovery Unit 310.
   Also, a pump 350 may be needed to circulate the heat transfer fluid through the Ambient Heat Collectors 325, Pre-Heater 335 and Vaporizer 340.
B) The “Work Extractor Unit” 315, which is designed to harness said pressure differential and convert it into more conveniently exploitable work:
   a. by enabling the Ambient Pressure of the gaseous Working Fluid expelled by the Heat Recovery Unit 310 (in the form of vapor pressure, also called saturated vapor) to exert stress on an expandable pressure vessel by pushing on and displacing a movable surface (possibly a gas distributor 360 and hydropneumatic cylinder 355 system as show in FIG. 3, a rotary vane motor or an air turbine). This may in turn, be coupled to an hydraulic distributor 365 and electric generator 220, converting this work into the production of power (e.g. electricity),
   b. by releasing this pressurized vapor into the cold sub-system 105.
C) The “Vapor Recovery Unit” 305 (i.e. the cold sub-system 105) is comprised of three elements, which successively enable the pressurized vapor expelled by the Work Extractor Unit 315 to retrieve a liquid state of matter⁽¹¹⁾:
(i) The Expansion chamber 370:
   The Expansion Chamber 370 may comprise a pressure vessel where the pressurized vapor is expelled out of the Work Extractor Unit 355 and expands freely. This free expansion process⁽⁸⁾ being generally isentropic needs no external energy source. This process results in a natural cooling of the gaseous Working Fluid, which generates a cold Ambient Temperature associated with the nature of the substance, close to the dew point ranging generally between −20° C. (−4° F.) and −80° C. (−112° F.), and causes the Working Fluid to partially re-liquefy.
(ii) The Vacuum Pump 375:
   The gaseous Working Fluid is then redirected from the Expansion Chamber 370 into a storage container, by means of a Vacuum Pump 375 (for example, a liquid ring pump where liquid Working Fluid forms the compression chamber seal, or more simply a rotary vane pump), which draws out the vapor from the Expansion Chamber 370 and impels it into the storage container/bubbling condenser 380. This process of injection results in a small compression of the gaseous Working Fluid causing most of the resulting saturated vapor to liquefy. Also, this process maintains the Ambient Pressure of the Expansion Chamber at a gauge pressure between 0.1 and 2 bars.
(iii) The Bubbling Condenser 380:
   To achieve the recovery of the vapor into the Working Fluid's liquid phase, the process is completed by letting the minimal amount of remaining saturated vapor bubble when traversing the liquid Working Fluid already present in the cold storage container (therefore called the “Bubbling Condenser” 380). Such an operation causes a direct contact heat exchange, achieving the liquefaction of the vapor.
The liquid Working Fluid then is stored in the cold sub-system 105 at the cold Ambient Temperature and Ambient Pressure corresponding approximately to its Normal State Function, until it is pumped back to the Heat Recovery Unit 310 via pump 385, closing the loop and re-initialize the process.
Choice of the Working Fluid
As seen above, the Pressure Power Unit 300 relies on the performance of the following three processes with regard to the Working Fluid:
   the vaporization
   the work extraction
   the liquefaction
All of these mainly result from the nature of the substance of the Working Fluid, whose N.B.P. and reference values cause different state functions in both cold and warm sub-systems, which are determined by the Working Fluid's physical properties of:
   Volatility
      the tendency of the substance to vaporize^{Error! Reference source not found.},
   Expansion factor
      the volatility results in a significant augmentation in volume Error! Reference source not found.,
   Vapor/Liquid Equilibrium
      the Working Fluid naturally vaporizes/condenses until “saturated” at its Vapor/Liquid Equilibrium⁽¹⁴⁾.
   Normal State Function
      the reference value is the Normal Boiling Point⁽¹⁵⁾,
   Critical point
      at which the phase boundary ceases to exist⁽¹⁶⁾,
   Nature of the Substance
      The Working Fluid generally is made of compound substances, often organic or refrigerants, characterized by a state of matter which varies according to the Ambient Temperature and Ambient Pressure related to reversible phase changes from gas to liquid and reverse.
      Many compound substances and refrigerants are blends of other compounds. The properties of a blend are modified easily by changing the proportions of the constituents. In many countries, use of refrigerants as a Working Fluid is regulated. Refrigerants were traditionally fluorocarbons, especially chlorofluorocarbons, but these are being phased out because of their ozone depletion effects. Other common refrigerants now used in various applications are near-azeotropic mixtures (like R-410A=HFC-32/HFC-125), fluoryl, ammonia, sulfur dioxide and non-halogenated hydrocarbons. Of course, other standard compound and organic substances may be used instead, such as butane, propane or methane, or chemical elements like nitrogen and oxygen and compounds such as nitrous oxide and carbon dioxide, and new Working Fluids may be engineered with properties optimized to a specific design scenario of the Pressure Power System (e.g. for enabling lower or higher Ambient Temperatures in the cold and warm sub-systems but still offering similar workable Ambient Pressures). The properties of a number of suitable Working Fluids are presented in the “Glossary and Data” hereunder⁽¹⁷⁾.
Energy Sources
In the warm sub-system 110
The Ambient Temperature of the warm sub-system 110 results directly either from the surrounding area or room temperature, or from the exploitation of external thermal energy sources, including but not limited to:
   the redirection of remote green energy sources selected from the group consisting of the ambient temperature found in the atmosphere (immediately surrounding or not), geothermal, thermal solar, biomass, fuel cells, water flows such as seas, lakes, rivers, sea beds, aquifers or groundwater sources, heat gradient found underground in mine shafts and in the basements of buildings, greenhouses, and therefore a distance from the Pressure Power Unit,
   waste energy like commercial or industrial wastewater and heat recovery systems, or
   further by an external heater, boiler or vaporizer, possibly fueled by propane, natural gas, fossil fuel or other, a battery or electricity.
The only condition remaining is to gain a state function enabling sufficient pressure differential between the warm sub-system 110 and the cold sub-system 105 for extraction of work.
In the cold sub-system 105
On the cold side, the process of free expansion enables the Working Fluid to cool automatically. This process is nearly isentropic and therefore needs almost no external energy source to maintain naturally the Ambient Pressure of the cold sub-system at a gauge pressure generally between 0.1 and 2 bars (close to the atmospheric pressure) and near the N.B.P. temperature.
In fact, the Pressure Power Unit 300 only requires a backup mechanism which will hold, in any circumstances (e.g. when the Pressure Power Unit 300 is not working for any reason), the storage container (i.e. the Bubbling Condenser 380) at this nominal Ambient Temperature by using a complementary separate cooling source or device.
Note that the energy required to actuate these supplementary devices which consume energy (the cooling system and the Vacuum Pump 375) may be supplied by the Pressure Power Unit 300 production, as it represents only a very small percentage of the work extraction process.
Also, note that when using Carbon Dioxide as the Working Fluid, the minimum gauge pressure to maintain in the Vapor Recovery Unit 305 should be over 5 bars to enable transformation of the vapor into a liquid phase of the substance.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The present invention will be further understood from the following detailed description with reference to the drawings in which:

FIG. 1 presents a concept diagram of a Pressure Power System in an embodiment of the invention;

FIGS. 2, 3 and 4 present block diagrams of various embodiments of Pressure Power Units of the invention;

FIG. 5 presents a block diagram of a Heat Recovery Unit in an embodiment of the invention;

FIG. 6 presents a detail of a Heat Recovery Unit in an embodiment of the invention;

FIG. 7 presents a profile section diagram of an extruded tube for a heat collector in an embodiment of the invention;

FIG. 8 presents a detail of a heat exchanger panel comprises a series of extruded tubes, in an embodiment of the invention;

FIGS. 9, 10 and 11 present details of the caps and seals of the extruded tubes of a heat exchanger panel, in an embodiment of the invention;

FIG. 12 presents a schematic diagram of a Work Extractor Unit in an embodiment of the invention;

FIG. 13 presents a schematic diagram of a Double Action Hydropneumatic Linear Actuator in an embodiment of the invention;

FIGS. 14A and 14B present section diagrams of an Air Distributor in an embodiment of the invention;

FIG. 15 presents a schematic diagram of a Hydraulic Rectifier in an embodiment of the invention;

FIG. 16 presents a schematic diagram of a exemplary Vapor Recovery Unit in an embodiment of the invention;

FIG. 17 presents a section diagram of a Vacuum Pump in an embodiment of the invention;

FIG. 18 presents a section diagram of a Bubbling Condenser in an embodiment of the invention; and

FIG. 19 presents a block diagram of an exemplary Pressure Power Unit in an embodiment of the invention.

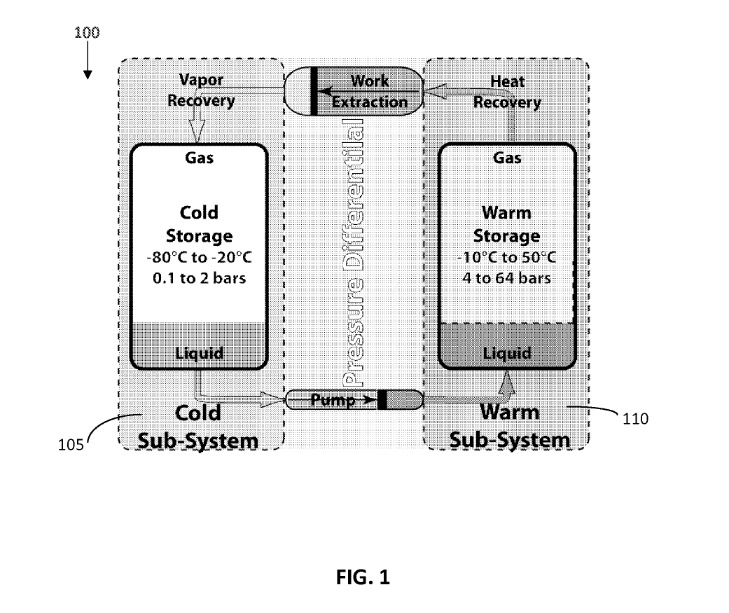

### BRIEF DESCRIPTION OF PREFERRED EMBODIMENTS OF THE INVENTION

The basic embodiment of the Pressure Power Unit described herein represents one way of manufacture for exploiting the novel concept of this invention. Of course, other frameworks, designs and models of the parts and their components, or different embodiments may be engineered by developers with skill in the art. These other enhancements and means of manufacture will still represent ways of exploiting the same inventive technology.

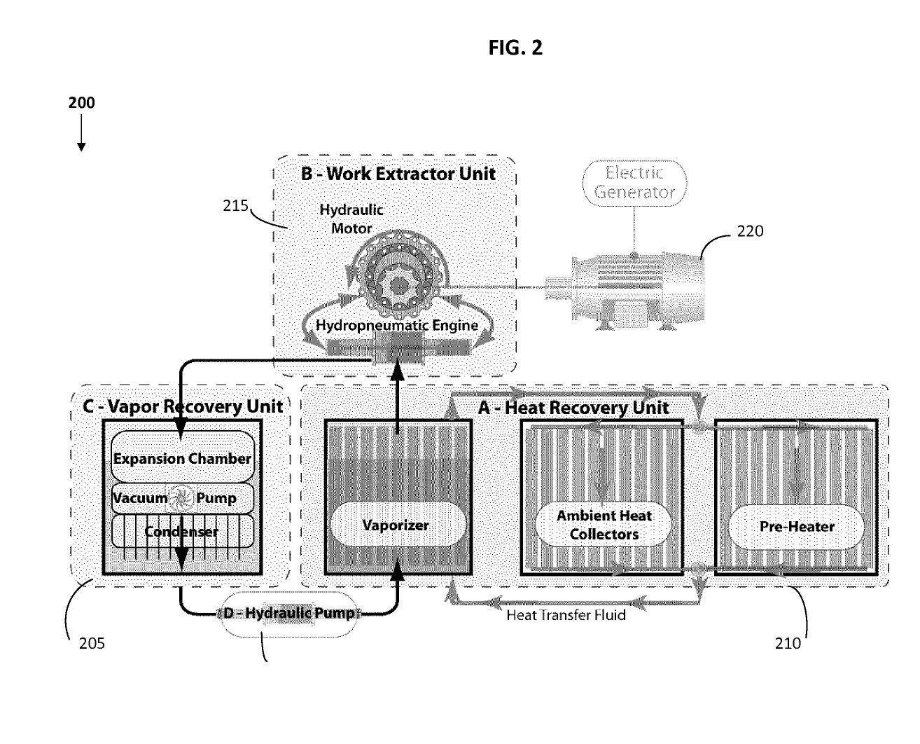

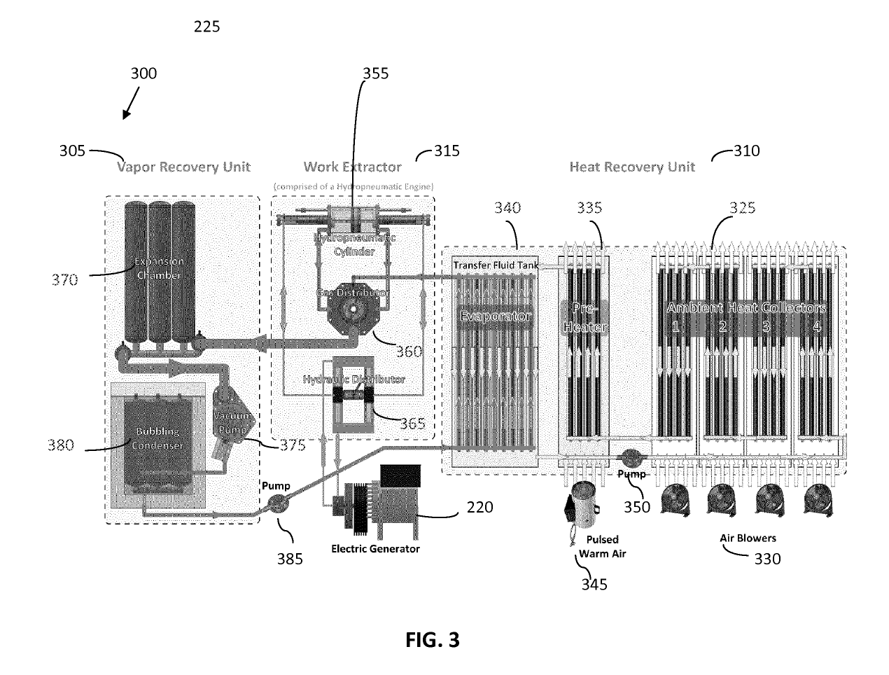

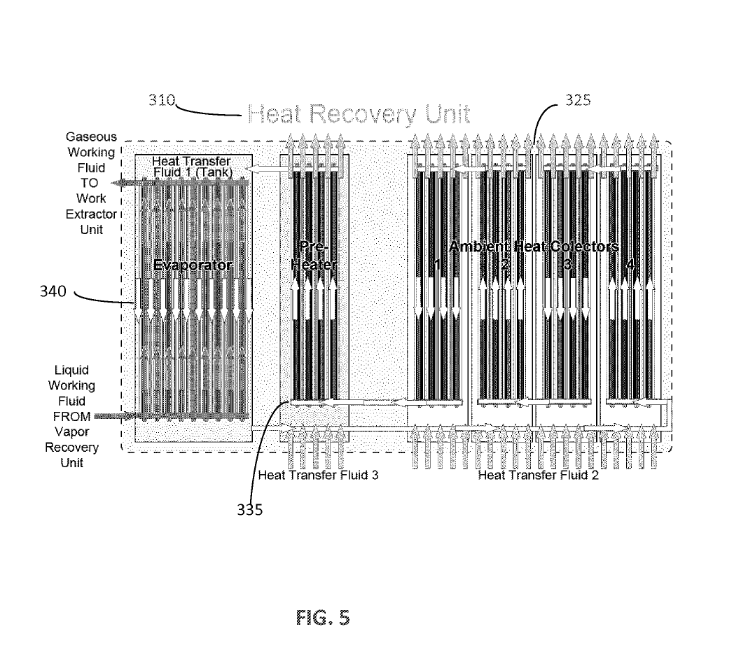

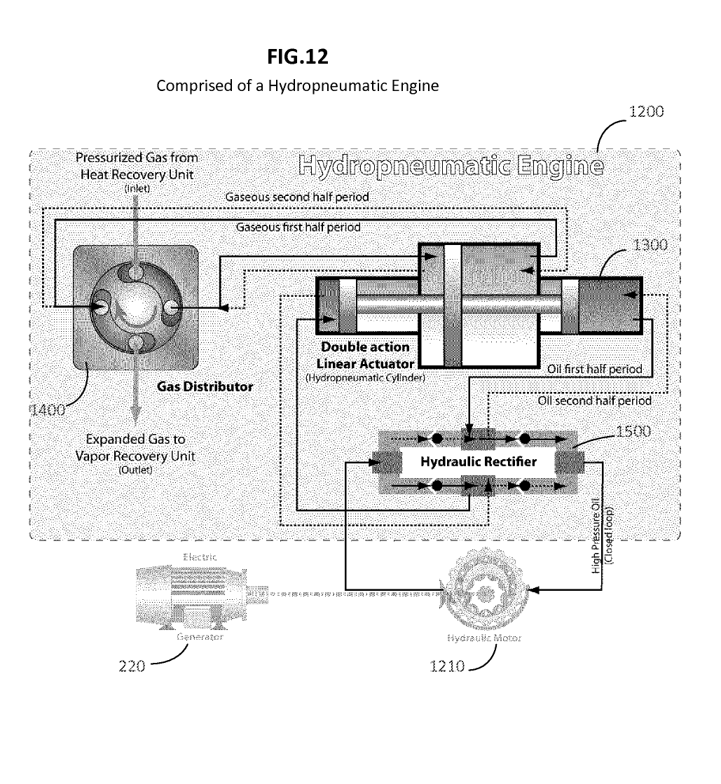

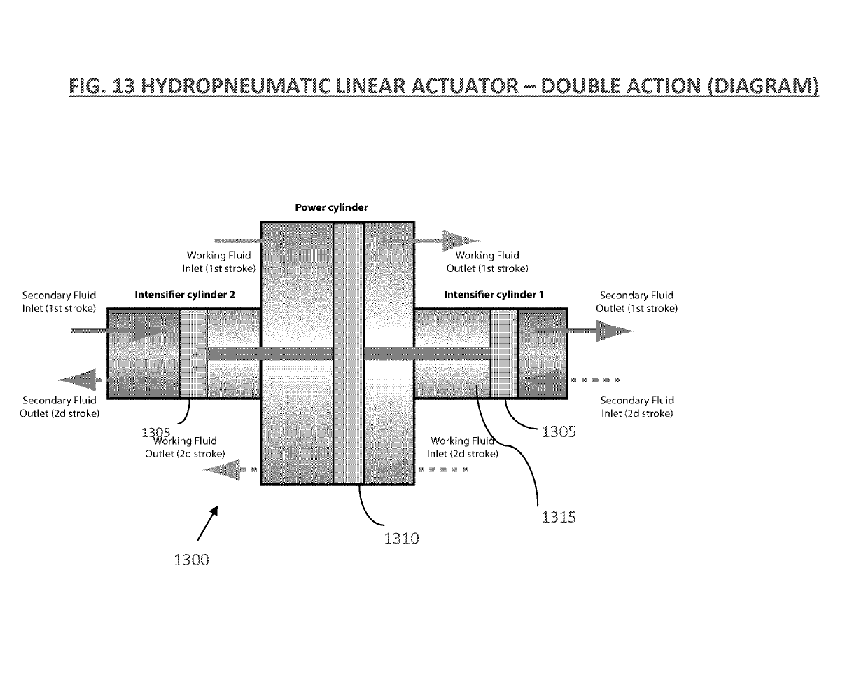

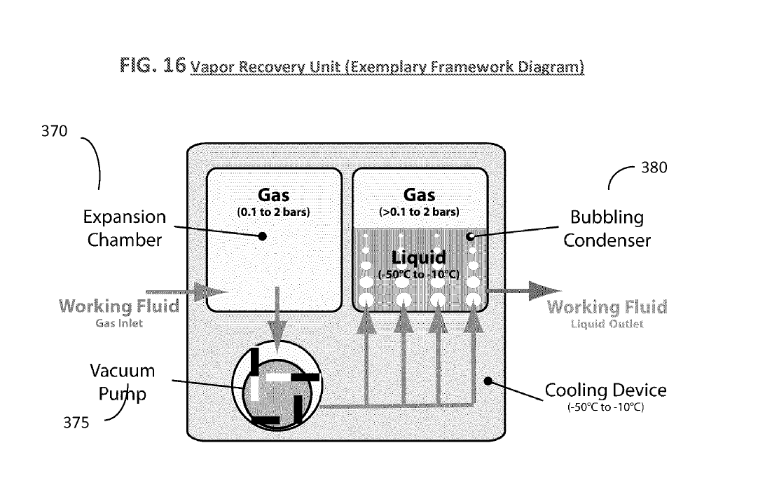

The main criterion of the design is to enable the Pressure Power Unit to maintain the vapor/liquid equilibrium of the Working Fluid at each specific level required by the successive steps of the cyclic path of energy collection and transformation, when circulating from the warm sub-system 110 to the cold sub-system 105, to produce power. In this regard, an exemplary Pressure Power Unit 200 is made basically of three main parts (see FIG. 2):
The “Heat Recovery Unit” 210, which comprises:
   the “Vaporizer”,
   the “Ambient Heat Collectors”, and possibly
   the “Pre-Heater”,
The “Work Extractor Unit” 215, and
The “Vapor Recovery Unit” 205, which comprises:
   the “Expansion Chamber”,
   the “Vacuum Pump”, and
   the “Bubbling Condenser”.
An hydraulic pump 225 completes this basic framework to return the liquid Working Fluid from the Vapor Recovery Unit 205 to the Heat Recovery Unit 210.
To achieve these objectives, different specificities and constraints have to be considered which determines the design of each component of the Pressure Power Unit 200 according to its particular function.
Heat Recovery Unit 210, 310
Referring to FIG. 5, the core of the Heat Recovery Unit 210, 310, i.e. the warm sub-system 110, is represented by a pressure vessel enabling the storage of the Working Fluid and is comprised of heat exchangers 325, which warm the Working Fluid and causes part of the liquid to vaporize, thereby transforming the surrounding thermal energy sources into elastic potential energy within the gaseous Working Fluid, per se generating the pressure head within the warm sub-system 110. To perform this function, the Heat Recovery Unit 210, 310 comprises:
A. The Vaporizer 340:
   The Vaporizer is engineered specially to work as a double action heat exchanger:
      which functions as direct contact heat exchange between the Working Fluid, which is circulated from the cold sub-system 105, and the Working Fluid already stored in the Vaporizer 340,
      which functions as conductive heat exchange, which extracts heat from the surrounding heat transfer fluid, at room or indoor temperature, and thereby maintains constant the Working Fluid's Ambient Temperature in the Vaporizer 340.
   The Vaporizer 340 is preferably designed as a “double action pressure vessel” which enables:
      Tight Insulated Storage
      As a storage container for the Working Fluid,
         with Ambient Pressures which may vary between 0.1 bars/1.5 psi (gauge pressure) to 64 bars/928 psi;
         with Ambient Temperatures, which may vary from −10° C./14° F. to +80° C./176° F.;
         with various Working Fluids, which may form a saturated mixture of vapor/liquid at equilibrium vapor pressure (referred hereunder as “vapor”), but generally each with a Normal Boiling Point (“NBP”) below −20° C./−4° F.; and
      Heat Exchanger
      As a heat exchanger designed to function with a double action:
   (i) Direct Contact Heat Exchanger Columns
      Enabling a direct contact heat exchange of the Working Fluid when liquid is pumped into the warm sub-system 110. Therefore, the Vaporizer 340 is designed specially like a heat exchanger column, sized to facilitate the vaporization process.
   (ii) Shell & Tube Heat Exchangers
      Also, to keep the state of matter of the Working Fluid at a constant value, the Vaporizer 340 is designed to work as a conductive heat exchanger, with an exchange surface optimized to the maximum, which maintains the temperature equilibrium between the Ambient Temperature of the Working Fluid and the temperature of the surrounding heat transfer fluid.
B. The Ambient Heat Collectors 325:
   When desired, to enable the collection of heat from the surroundings or from remote thermal energy sources and enhance the balancing in the Vaporizer 340 of the vapor/liquid equilibrium of the Working Fluid's state of matter, other heat exchangers, i.e. “Ambient Heat Collectors” 325, can be added within the Heat Recovery Unit 210, 310.
   The Ambient Heat Collectors 325 are generally comprised of heat exchangers designed to collect thermal energy from additional sources: e.g. green energy, geothermal, thermal solar, biomass, water flows, heat gradient found underground, but also commercial or industrial waste energy and heat recovery systems or a gas burner. Then, this thermal energy is directed to the Vaporizer 340 by using a secondary circuit of heat transfer fluid, working as the heat energy source of the Vaporizer 340. Also, by using such heat transfer fluid, remote heat energy sources may be located at a distance from the Pressure Power Unit 200, 300, enabling the exploitation of the device to work as a “Hybrid Energy Pressure Power Unit”.
   One should note that these heat exchangers, working only to warm a flow of heat transfer fluid, do not require any specific design for enabling the devices to withstand significant pressures.
C. The Pre-Heater 335:
   The Heat Recovery Unit 210, 310 may be supplemented with a complementary Ambient Heat Collector, i.e. the “Pre-Heater” 335, which may be used to punctually produce more warm heat transfer fluid, for example, by means of a gas burner 345 (see FIG. 3).
   Such a supplementary device should be installed when the possibility exists that from time to time the regular source of thermal energy may not be sufficient to warm the Heat Recovery Unit 210, 310 enough for raising the Ambient Temperature within the Vaporizer 340 which would enable the Working Fluid in the Heat Recovery Unit 210, 310 to reach the required Ambient Pressure.
   Work Extractor Unit 215, 315
   To convert pressure to mechanical, electrical or other useful energy and thereby make possible the extraction of work and the production of power, different embodiments of a Work Extractor Unit 215, 315 may be engineered in a number of ways, for instance using turbines, pressure transformers or any other machine which exploits a pressurized gas flow to convert it into mechanical motion and thereby produce kinetic energy. The most efficient approaches to be taken for engineering the design of the Work Extractor Unit 215, 315 include either:
A. Air turbines:
   Air turbines are pneumatic motors which convert by expansion the pressurized Working Fluid's energy of a gas flow to mechanical work and thereby create the rotary motion which actuates the power generator.
   However, one should consider the efficiency factor that such technology would have within the Pressure Power Unit 200, 300, as the process of expansion/rotary motion requires:
      with an impulse turbine, the fluid's pressure head to be changed beforehand into velocity head to transform the elastic potential energy into kinetic energy, which results in a precipitate cooling of the Working Fluid and a reduced working volume, and
      with a reaction turbine, multiple stages must be used to harness the expanding gas efficiently, which progressively cools and causes partial liquefaction of the Working Fluid, which results in lower efficiency.
   Also one should consider that any turbine generally reduces the efficiency of a free expansion process installed downstream by the Vapor Recovery Unit 205, 305 and may thus hinder the natural cooling it requires.
B. Reciprocating engines:
   A reciprocating engine uses one or more pistons to convert the pressure of the gaseous Working Fluid into a rotary motion.
   Two types of reciprocating engine may be considered to convert the pressurized gas energy to mechanical work through either linear or rotary motion: linear motion can come from either diaphragm or piston actuators, while rotary motion is supplied by either a vane type air motor or piston air motor.
   However, rotary motion technologies require some form of lubrication, which causes issues of compatibility with the organic Working Fluids to be used within the Pressure Power Unit 200, 300 and requires filter mechanisms, which may damage the Working Fluid, causing a quicker loss of its properties.
C. Linear Actuators:
   This enables the Work Extractor Unit 215, 315 of a Pressure Power Unit 200, 300 to use preferably a series of linear actuators which may be designed easier and without lubrication when working with the vapor pressure resulting from the vaporization of the Working Fluid in use in the Pressure Power Units 200, 300 while it enables keeping the entire benefit of the free expansion process. FIGS. 12 and 13 present exemplary schematic diagrams of such a device.
Vapor Recovery Unit
The core of the Vapor Recovery Unit 205, 305, i.e. the cold sub-system 105, is represented by a pressure vessel enabling the re-liquefaction and the storage of the Working Fluid.
To perform these functions within the Pressure Power Unit, three processes are required, each represented by a specific device (as shown in FIG. 16, for example):
A. The Expansion Chamber 370
   Simply comprised of a pressure vessel (i.e. a storage container), the Expansion Chamber 370 enables the pressurized vapor, which is expelled out of the Work Extractor Unit 215, 315, to expand freely naturally.
   In the Pressure Power Unit 200, 300, this free expansion process results in the natural cooling of the gaseous Working Fluid, which generates a cold Ambient Temperature, corresponding to a little above its dew point, generally between −20° C. (−4° F.) and −80° C. (−112° F.).
   Said cooling causes the Working Fluid to gain a specific equilibrium vapor pressure corresponding to this low temperature, which results in a partial liquefaction, thereby forming a specific saturated mixture of vapor/liquid (i.e. the vapor).
B. The Vacuum Pump 375
   To maintain the Ambient Pressure within the Vaporizer 305 at about atmospheric pressure, a Vacuum Pump 375 draws the Working Fluid's vapor out of the Expansion Chamber 370 at the same rate as it is created by the free expansion process. The vapor is then redirected by the Vacuum Pump 375 into the Bubbling Condenser 380.
   To expel the fluid in the Bubbling Condenser 380, the Vacuum Pump 375 needs to compress the vapor a little bit, so that it overcomes the Ambient Pressure in the downstream device.
   However, by increasing the Ambient Pressure of the vapor, the Vacuum Pump 375 modifies the vapor/liquid equilibrium of the Working Fluid and automatically causes a phase change, which adjusts its state of matter, thereby making the Working Fluid condense and liquefy.
   This limited compression process is sufficient to cause most of the fluid to liquefy but does not complete the process entirely so that some saturated mixture of vapor/liquid remains in the expelled fluid.
C. The Bubbling Condenser 380
   To complete the process of liquefaction of the Vapor Recovery Unit 205, 305, a second pressure vessel, i.e. the Bubbling Condenser 380, is used as a storage container of the liquid Working Fluid.
   The bubbling condenser 380⁽⁹⁾ works as a particular type of direct contact condenser. Any remaining saturated mixture of vapor/liquid of Working Fluid, when injected by the Vacuum Pump 375 into the liquid stored in the Bubbling Condenser 380, forms bubbles. The Temperature/Pressure equilibrium naturally causes these bubbles to mix completely with the liquid, by direct contact heat exchange, thereby achieving the re-liquefaction. The process enables naturally maintaining the Bubbling Condenser 380 at a similar Ambient Temperature (i.e.: between −80° C. and −20° C./−112° F. and −40° F.). and consequently at a similar Ambient Pressure (i.e. between 0.1 and 2 bars/1.5 and 29 psi) as the Expansion Chamber 370, close to the Normal Boiling Point (“N.B.P.”) of the Working Fluid.
Hydraulic Pump 225, 385
To close the loop of the Working Fluid cycle, per se to regulate the circulation of the Working Fluid in the Pressure Power Unit circuit, a Hydraulic Pump 225, 385 is installed between the cold sub-system 105 and the warm sub-system 110 to pump the liquid Working Fluid back into the Vaporizer 340.

### Exemplary Embodiment

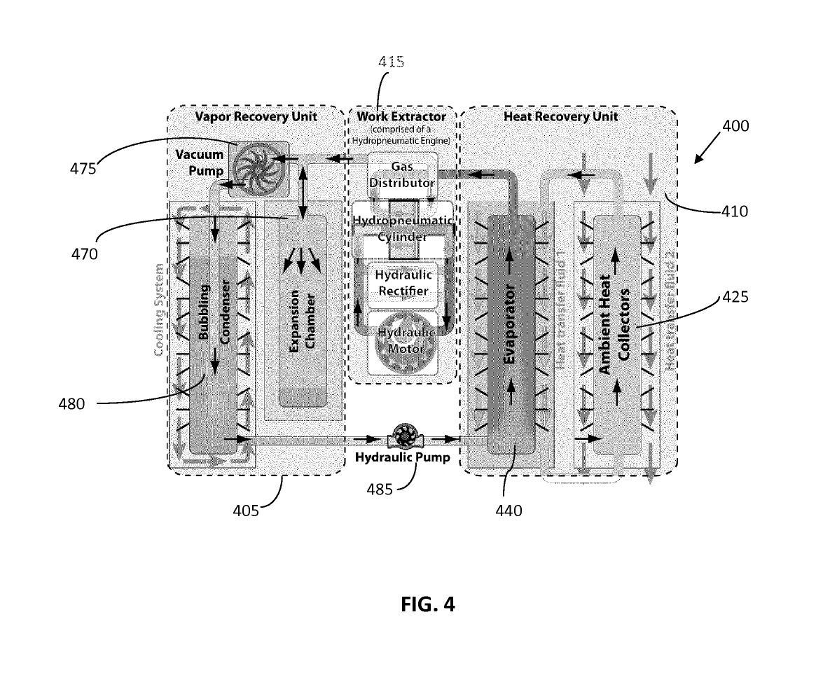

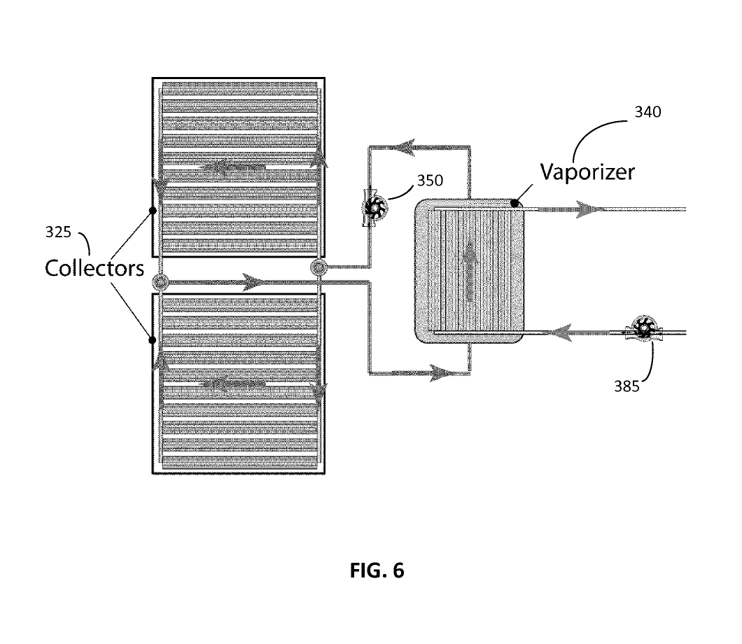

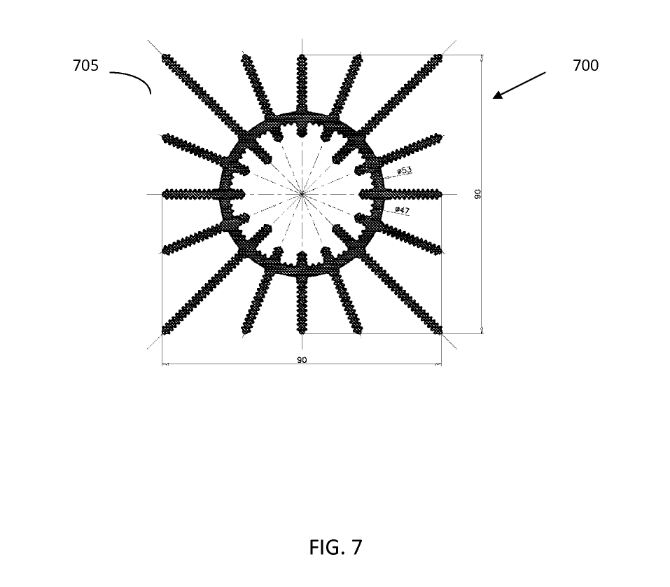

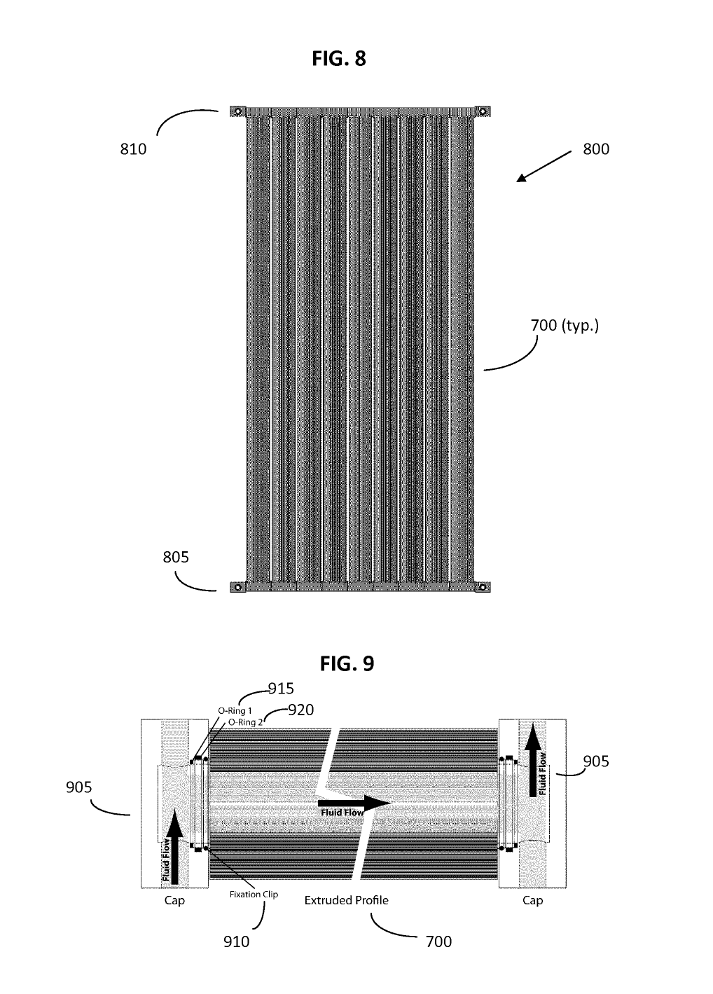

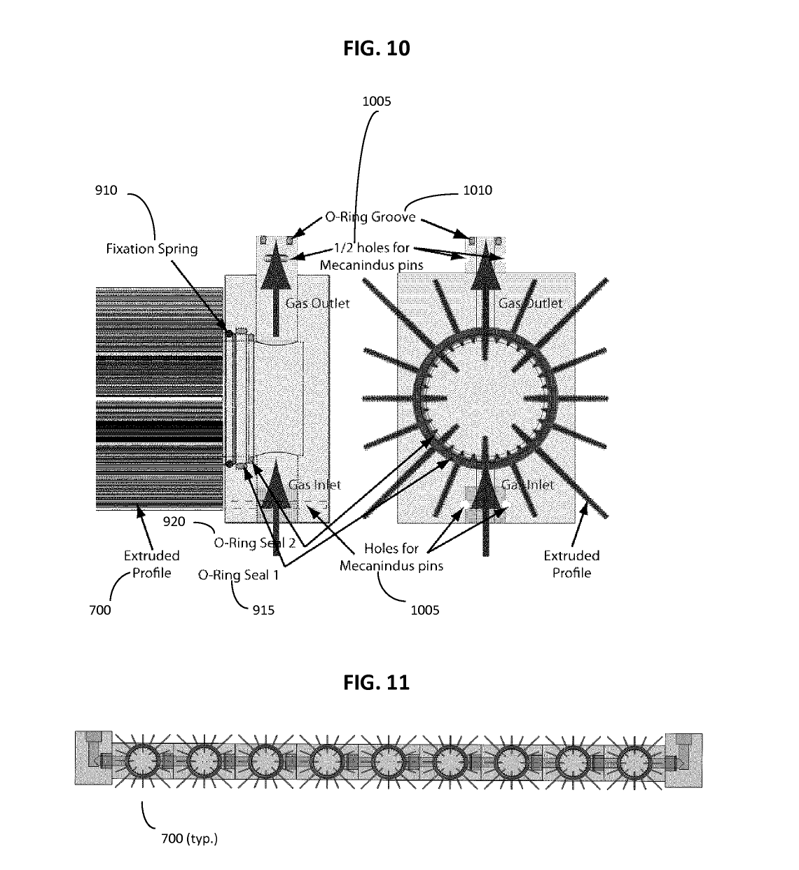

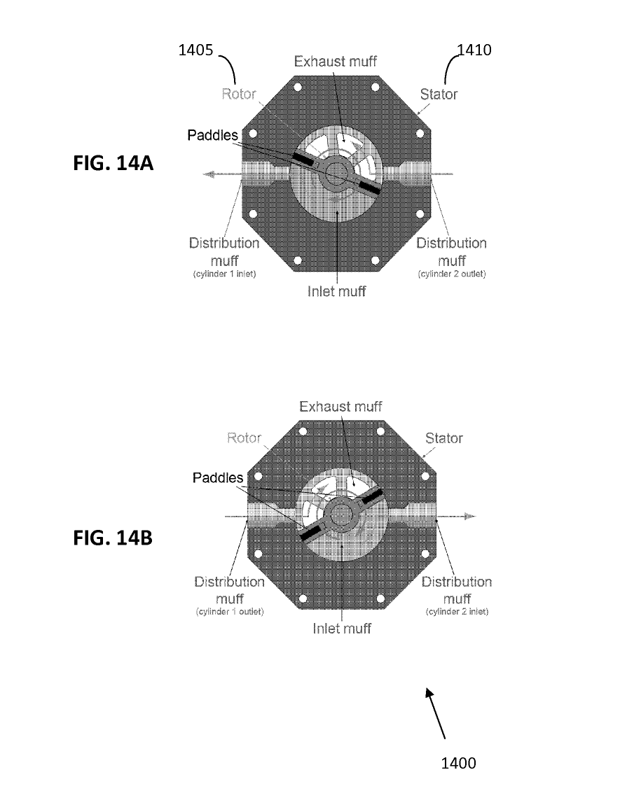

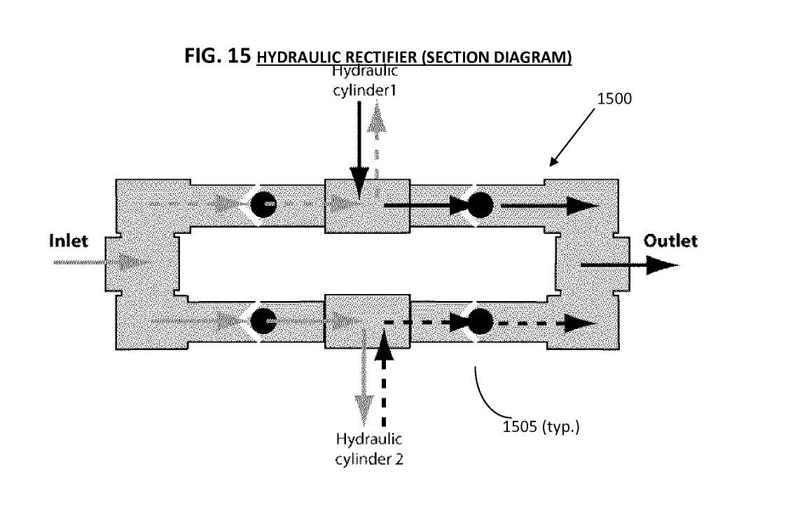

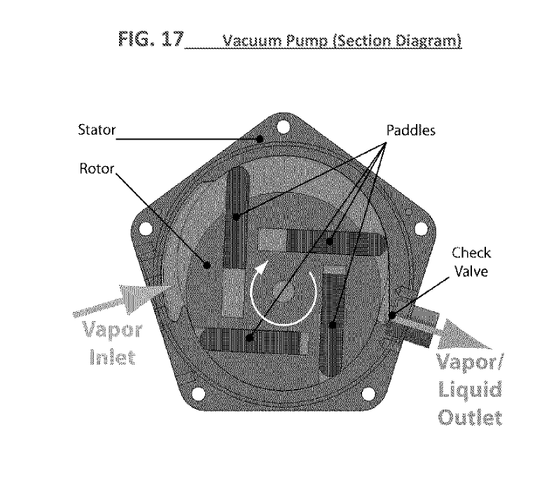

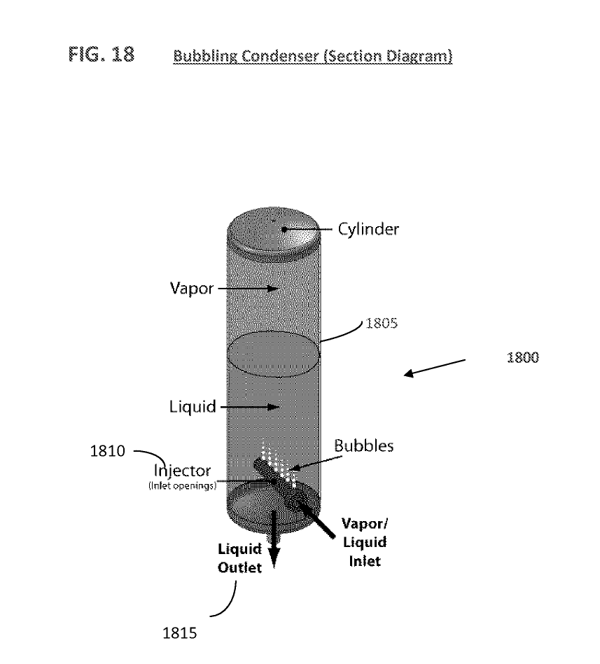

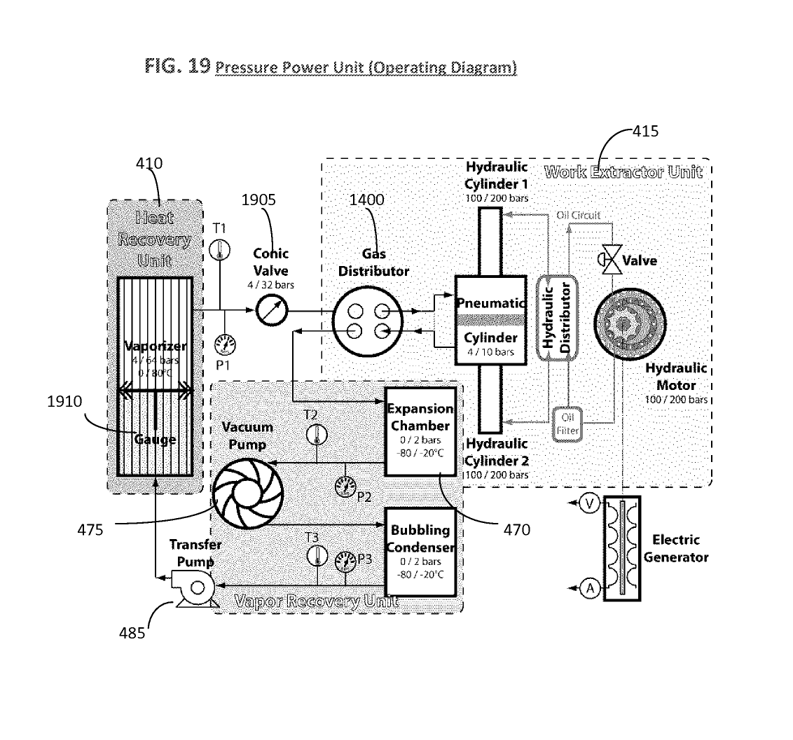

The exemplary embodiment of the Pressure Power Unit described hereunder is based on a specific choice of the parts and components, which does not preclude the use instead of other design or framework approaches, as possibly engineered by developers with skill in the art without departing from the basic concepts of this invention.
Structure Design
The structure of this exemplary embodiment consists of the following components (see FIG. 3):
   Heat Recovery Unit 310
   The exemplary Heat Recovery Unit 310 is designed to enable exploiting the surrounding air as the primary heat source. This is accomplished with the following components:
      a series of Ambient Heat Collectors 325 (made of a series of heat exchanger modules), each equipped with an air blower 330 which circulates the air (used as first heat transfer fluid) for maintaining the water flowing through the collectors (used as second heat transfer fluid) at the surrounding temperature, preferably greater than the Ambient Temperature which must be reached within the Vaporizer 340;
      a Pre-Heater 335 (also made of a series of heat exchangers), using pulsed warm air 345 (e.g. heated with a gas burner or other source of heat) completes said heat collection circuit for enabling additional warming of the second heat transfer fluid whenever needed (e.g. overnight or in winter when the surrounding temperature is not sufficient to attain said Ambient Temperature;
      the Vaporizer 340, comprised of another series of heat exchanger modules, uses in turn the second heat transfer fluid to warm and maintain the Working Fluid at the required Ambient Temperature; and
      a hydraulic pump 350 circulates the second heat transfer fluid through the circuit.
   Work Extraction Unit 355
   The exemplary work extraction process is achieved by a Hydropneumatic Engine, which exploits the Ambient Pressure of the pressurized vapor produced by the Vaporizer 340 to convert this medium pressure (between 4 and 64 bars) by multiplying such force into a high pressure hydraulic flow (e.g. an oil flow ranging between 100 and 300 bars) which enables actuating an electric generator 220. Therefore the Hydropneumatic Engine comprises:
      a Gas Distributor 360, which is specially designed to fit with the volume of vapor produced by the Vaporizer, it alternately directs the pressurized vapor flow to each of the Hydropneumatic Cylinders;
      the Hydropneumatic Cylinders 355, which work primarily as a pneumatic actuator to transform the elastic potential energy (i.e. the pressure head) of the pressurized vapor into linear motion by displacing its pneumatic piston. Said large piston, being directly mounted on a common shaft with two hydraulic actuators with smaller pistons, works thus secondarily as a pressure multiplier which produces an alternate flow of hydraulic fluid (e.g. oil);
      a Hydraulic Distributor 365 (also called hydraulic rectifier), which is made of a series of check valves to transform the alternate hydraulic flow in a continuous stream, thereby enabling to power the electric generator.
   Vapor Recovery Unit 305
   The re-liquefaction of the pressurized vapor is based on the principle of the free expansion, the exemplary Vapor Recovery Unit 305 being comprised of:
      an Expansion Chamber 370, which is made of a large pressure vessel wherein the pressurized vapor expelled out of the Hydropneumatic Cylinders 355 may freely expand to about the normal state of matter of the Working Fluid, i.e. close to the atmospheric pressure, thereby cooling naturally close to its N.B.P.
      a Vacuum Pump 375, which for this exemplary embodiment is designed as a rotary vane pump for sucking the vapor out of the Expansion Chamber 370 and thereby maintain it at about atmospheric pressure, then compressing a little the vapor and thereby liquefying the Working Fluid, before expelling the resulting vapor/liquid mixture into the Bubbling Condenser 380;
      a Bubbling Condenser 380, comprised of one or a series of pressure vessels designed as columns wherein the vapor/liquid mixture is injected by passing through a large number of openings (the gap/cap inlet openings), via a series of valves or porous plugs, forcing the vapor remaining in the mixture to flow through the liquid Working Fluid already stored in the Bubbling Condenser 380, thereby achieving the liquefaction process.
   Circulation Pump 385
   To close the Working Fluid circuit and enable the re-initialization of the Pressure Power Unit process, a standard hydraulic pump 385 is installed between the Bubbling Condenser 380 and the Vaporizer 340 to circulate the Working Fluid which was recondensed.
   Embodiment design
   As shown in FIG. 4, an exemplary framework of the Pressure Power Unit 400 may be comprised of:
   Heat Recovery Unit 400
   Functioning as a heat exchanger, the Vaporizer 340, the Ambient Heat Collectors 325 and the Pre-Heater 335 proposed in this exemplary embodiment of Heat Recovery Unit 400 are based on a specific design which enables years of continuous work regardless of the working or transport conditions, without risk of leaks, due to precision engineering and manufacturing with tight seals that precludes or reduces the need for any welding.
   As shown in FIGS. 5 and 6, the Heat Recovery Unit 400 comprises a series of sets of heat exchanger tubes. The heat exchanger tubes are manufactured as innovative extruded aluminum profiles as shown in the cross-section of FIG. 7. Each extruded tube 700 includes vanes 705 on both the inside and the outside of the tube 700. Each vane 705 has additional fins which run generally perpendicular to the plane of the vane 705. This increases the overall surface area of the extruded tube 700, resulting in better heat transfer for a given diameter of extruded tube 700.
   As shown in FIG. 7, the lengths of the vanes 705 are different, to maximize their respective lengths without interfering with one another. On the outside of the extruded tube 700 for example, the overall pattern of the vane lengths is established to have a profile which would fill a square shape. Of course, additional patterns may also be used to achieve the same effect.
   As shown in FIG. 8 the extruded tubes 700 are assembled together into panels 800, with an intake manifold 805 and an outlet manifold 810. Other parameters of these panels 800 are as follows:
      extruded tubes 700 can be manufactured at low cost;
      The material (aluminum) has an advantageous thermal inertia ratio;
      As shown in FIG. 7, the design of the extruded tubes 700 uses a profile with paddles inside and outside the extruded tubes 700, comprising fins, ridges and grooves, which enlarge the exchange surfaces, providing a better exchange coefficient;
      Each extruded tube 700 is assembled as a separate module, using caps 905 (also called “sleeves”) on each extremity per FIG. 9, which facilitates gathering the extruded tube 700 in the panels 800;
      the specially designed caps 905 use metal spring clips 910 as shown in FIGS. 9 and 10 to be fixed on the extruded tube 700 without any welding, and a double O-Ring sealing 915, 920 provides a seal able to afford Ambient Pressures up to 64 bars (928 psi) and Ambient Temperatures over 180° C. (360° F.). Also, this technology for assembling the extruded tubes 700 enables multiple modules to be gathered in bundles simply using “Mecanindus” pins to attach two caps 905 together, themselves tight insulated with another O-Ring 1010. The holes 1005 for the Mecanindus pins are shown in FIG. 10, as are the grooves for these O-rings. FIG. 11 shows a series of extruded tubes 700 assembled together via the caps 905, Mecanindus pins and O-rings;
      the shape of the exemplary extruded tube 700 profiles is particularly efficient with liquid/liquid heat exchanges but also enables use of any kind of liquid as well as gaseous Working Fluids and heat transfer fluids (HTF);
      The size of the section of the extruded tubes 700, used vertically as columns, facilitates the evaporation of the Working Fluid;
      The length of the extruded tubes 700 (determining the length of the path of the fluids) may be adapted up to 6 meters, which is a standard dimension for aluminum extruded profiles, but possibly may be manufactured even longer;
      Each panel 800 forms a separate module using a “shell and tubes” bundle assembly of several profile modules, enabling the panels 800 to be sized to suit a user's needs;
      The number of modules gathered to form a heat exchanger may vary upon needs; and
      Also, the number of heat exchanger panels 800 which are used together may be adapted to render precisely the desired heat exchange capacity.
   Work Extractor Unit 415
   This exemplary embodiment of the Pressure Power Unit 400 employs a Work Extractor Unit 415 exploiting linear motion as shown in FIG. 12, using a series of hydropneumatic cylinders 1300 as piston actuators. This Hydropneumatic Engine 1200 may be designed for use without lubrication.
   The Working Fluid, in the form of pressurized vapor as generated by the Vaporizer 340 in the primary circuit, is circulated to a series of Hydropneumatic Cylinders 1300, each combining linearly two hydraulic actuators 1305 with a pneumatic actuator 1310 by coupling them on a common shaft 1315 as shown in FIG. 13. The vapor flow is directed alternately on each pneumatic actuator 1310 side, thereby exerting a reciprocating force on the piston and transforming the elastic potential energy into kinetic energy.
   This force being transmitted directly by the shaft 1315 to the hydraulic actuators 1305, which presents a smaller section surface, produces a multiplied force to cause oil or hydraulic fluid to circulate in a secondary circuit under high pressure, used to actuate the power generator.
   To enable reciprocation, the Hydropneumatic Engine 1200 also comprises:
      A “Gas Distributor” 1400 which directs the pressurized vapor flow out of the Vaporizer 340 alternatively to the different inlets of the pneumatic actuator 1310. As shown in FIG. 14, by using a switch, made of a rotor 1405 within a stator 1410 comprising a series of apertures, the pressurized vapor is successively addressed to each inlet of the pneumatic actuators 1310 while enabling the simultaneous outlet of the opposite pneumatic actuator's outlet. The rotor motion, being actuated by a variable speed electric motor, enables modification of the flow speed supplied to the pneumatic actuators 1310 and thereby regulates the resulting hydraulic flow so that it may be adjusted to the number of RPMs required by the electric generator 220.
      A “Hydraulic Rectifier” or Hydraulic Distributor 1500 per FIG. 15, which alternately collects the hydraulic flow expelled by each couple of hydraulic actuators 1305 and redirects the flow, by using check valves 1505, in the same direction in the secondary hydraulic circuit.
   Then, in the secondary hydraulic circuit, the Hydropneumatic Engine 1200 is able to exploit the kinetic energy of a high pressure liquid flow to power a hydraulic motor 1210, possibly for actuating an electric generator 220.
   Vapor Recovery Unit 405
   An exemplary embodiment of the Vapor Recovery Unit 405 is shown in FIG. 16, where the Working Fluid, in the form of pressurized vapor as expelled by the Work Extractor Unit 415, is expelled into its first component:
      The Expansion Chamber 370:
      To enable the free expansion of the vapor, this device is designed as a pressure vessel with a large volume which is dimensioned to offer a capacity equivalent to the flow volume of vapor expelled by the Work Extractor Unit 415 every second, when computed at its N.B.P. values, per se at the atmospheric pressure. For example, if the Work Extractor releases 1 kg/sec of Freon R410A as Working Fluid, which is characterized by a liquid/gas volume occupancy ratio of 249 at −40° C./−40° F., the minimum capacity of the Expansion Chamber 370 should be about 250 L.
      The Expansion Chamber 370 is preferably manufactured as a pressure vessel to ensure that if the Ambient Temperature should increase and thereby the Ambient Pressure augment, e.g. when the Pressure Power Unit 400 fails for any reason, the device is able to resist a stress of up to 64 bars (maximum Ambient Pressure which may be attained by the gaseous Working Fluids in a Pressure Power Unit). Therefore, a cylinder shaped should be used as it represents the best form of closed container designed to hold gases and/or liquids at a pressure substantially different from the atmospheric pressure, and responds to parameters such as maximum safe operating pressure and temperature regulations in place.
      Possibly, to help in the manufacture of the cylinder with a very large capacity, the Expansion Chamber 370 may comprise a bundle of smaller cylinders, with a reduced section diameter, assembled in parallel.
      The Vacuum Pump 375:
      To maintain the Ambient Pressure in the Expansion Chamber 370, a Vacuum Pump 375 is installed to suck out the expanded vapor as quickly as the device is filling. In this exemplary embodiment a rotary vane pump of the kind shown in FIG. 17 is used.
      As in the example above, if 250 L/sec are expanding in the Expansion Chamber 370, the same volume must be sucked out by the Vacuum Pump 375, which is regulated by a pressure detector mounted in the chamber by maintaining its Ambient Pressure at a gauge pressure between 0.1 and 2 bars.
      The Bubbling Condenser 1890:
      To enable the remaining liquefaction of the vapor/liquid mixture expelled by the Vacuum Pump 375, the Bubbling Condenser 1800 is designed as a vertical pressure vessel 1805 as shown in FIG. 18. This vertical pressure vessel 1805 is designed to have a sufficient capacity to work as a storage container of the cold sub-system's liquid Working Fluid but also to hold some pressurized vapor enabling the process of liquefaction to achieve its vapor/liquid equilibrium at the Ambient Temperature met in the device. Here also, due to a possible increase of the Ambient Temperature (e.g. when the device fails for some reason and the surrounding cooling system is not working) to the surrounding temperature level, which could mean a possible Ambient Pressure up to 64 bars, this pressure vessel preferably uses a container shaped as cylinder(s).
      Bundled together vertically, each vertical pressure vessel 1805 is equipped with a specific injector sleeve 1810, itself directly connected to the outlet of the vacuum pump 375, which is positioned below the level of the liquid Working Fluid's bath, thereby enabling the vapor/liquid mixture expelled by the Vacuum Pump 375 to spread (and form bubbles) to achieve the liquefaction process. The outlet 1815 for the liquid Working Fluid, of course, is positioned in the bottom of the vertical pressure vessel 1805.
      To complete the installation, an independent cooling system surrounds the Bubbling Condenser 1800 (not shown) to ensure the maintenance of a stable cold Ambient Temperature close to the N.B.P. of the Working Fluid, which is used in the Pressure Power Unit 400.
   Hydraulic Pump 485
   Any model of standard hydraulic pump 485 may be used, under the sole condition that it works under temperatures as low as e.g. −50° C./−58° F., according to the Ambient Temperature within the cold sub-system's storage container (i.e. the Bubbling Condenser 380) as determined by the characteristics of the Working Fluid's N.B.P.
   Functional Control
   To operate this exemplary embodiment of the Pressure Power Unit, one must be able to regulate separately, based on his specific requirements, each of the processes of:
      Vaporization,
      Extraction of work,
      Condensation,
      Re-initialization.
   Referring to FIG. 19, this can be achieved as follows:
   Pressurized vapor flow
      Conic Valve 1905:
         The admission of the volume of pressurized vapor flow expelled by the Heat Recovery Unit 410 into the Work Extractor 415, is controlled by a valve, preferably a conic valve 1905. This enables the adjustment of the power to be produced by modifying the state function W=PV simply by varying the volume of pressurized vapor to be exploited. For example, the conic valve 1905 may be regulated automatically by controlling the power production of the Electric Generator (Watts). Should the Amperes be greater than needed, it is sufficient to reduce the pressurized vapor volume addressed to the pneumatic cylinders, and vice-versa.
   Extraction of Work
      Gas Distributor 1400:
         To control the motion speed of the piston within the hydropneumatic cylinders 1200, the alternate distribution of said pressurized vapor flow into both ends of each pneumatic actuator 1310 also needs to be regulated. Therefore the Gas Distributor 1400, which is a rotary device, requires a variable rotary speed so that it may be adjusted to produce the speed of hydraulic fluid flow as required by the RPMs of the hydraulic motor 1210. For example, the rotary speed may be regulated automatically by controlling the voltage produced by the Electric Generator 220. Should the voltage be greater than needed, it is sufficient to slow down the rotary speed of the Gas Distributor 1400, and vice-versa.
   Condensation
      Vacuum Pump 475:
         To maintain the Ambient Pressure in the Expansion Chamber 470, as the volume of free expanded vapor may vary when the above said processes are modified, the Vacuum Pump 475 needs to be controlled accordingly, which is possible simply by regulating the rotary speed of the vanes. To control the Ambient Pressure and Ambient Temperature within the Vapor Recovery Unit 405, sensors (i.e. manometers P1, P2 and P3, and thermometers T1, T2 and T3) control the nominal values of the sub-system and enable automatic adjustment of the Vacuum Pump 475.
   Re-initialization
      Transfer Pump 485:
         As the system modifies the vapor/liquid equilibrium in both the cold and warm sub-systems, the Vaporizer 440 sees the liquid volume reducing continuously while the Bubbling Condenser 480 sees the liquid volume increasing, but the total amount present in the circuit remains constant. Therefore, to re-equilibrate the nominal volumes of liquid it is sufficient to control the level in the Vaporizer 440 with a gauge instrument 1910 for regulating the action of the transfer pump 485 which consequently will re-initialize the system by pumping liquid out of the Bubbling Condenser 480 and re-injecting it in the Vaporizer 440.

### Conclusions

One or more currently preferred embodiments have been described by way of example. It will be apparent to persons skilled in the art that a number of variations and modifications can be made without departing from the scope of the invention as defined in the claims.

All citations are hereby incorporated by reference.

### GLOSSARY & DATA

### (1) State Function

In thermodynamics, a state function is a property of a system that depends only on the current state of the system, not on the way in which the system acquired that state (independent of path). A state function describes the equilibrium state of a system.

State functions are a function of the parameters of the system, which only depends upon the parameters' values at the endpoints of the path. Temperature, pressure, internal or elastic potential energy, enthalpy and entropy are state quantities because they describe quantitatively an equilibrium state of a thermodynamic system, irrespective of how the system arrived in that state.

It is best to think of state functions as quantities or properties of a thermodynamic system, while non-state functions represent a process during which the state functions change.

For example, in this document, the state function W=PV (“PV”=pressure multiplied by volume) varies proportionally to the internal energy of a fluid during the path in the system, but the work “W” is the amount of energy transferred as the system performs work: internal energy like the elastic potential energy is identifiable, it is a particular form of energy; work is the amount of energy that has changed its form or location.

Nota Bene:

To simplify the reading of this document, in said state function W=PV:
PV is regarded as the internal energy of the sub-system. The process of vaporization transforms some of said internal energy into another form referred to in this document as the “Elastic Potential Energy”, usually dimensioned in Joules.
W is considered as the corresponding extractable work, which is then usually dimensioned in Watts.

### (2) Equilibrium Vapor Pressure

The equilibrium vapor pressure is the Ambient Pressure exerted by a vapor in thermodynamic equilibrium with its condensed phases (solid or liquid) at a given temperature in a closed system. The equilibrium vapor pressure is an indication of a liquid's vaporization rate. It relates to the tendency of particles to escape from the liquid (or a solid). A substance with a high vapor pressure at normal temperatures is often referred to as volatile.

The vapor pressure of any substance increases non-linearly with temperature according to the Clausius-Clapeyron relation. The atmospheric pressure boiling point of a liquid (also known as the normal boiling point) is the temperature at which the vapor pressure equals the ambient atmospheric pressure. With any incremental increase in that temperature, the vapor pressure becomes sufficient to overcome atmospheric pressure and lift the liquid to form vapor bubbles inside the bulk of the substance. Bubble formation deeper in the liquid requires a higher pressure, and therefore higher temperature, because the fluid pressure increases above the atmospheric pressure as the depth increases.

### (3) Ambient Temperature

In the following descriptions and references, Ambient Temperature means the temperature of a Working Fluid, within a surrounding device, such as the temperature in a container, piece of equipment or component in a process or system.

### (4) Ambient Pressure

In the following descriptions and references, the Ambient Pressure of a system is the pressure of a Working Fluid, exerted on its immediate surrounding, which may be a container, particular device, piece of equipment or component in a process or system.

The Ambient Pressure varies as a direct relation to the Ambient Temperature of the Working Fluid and corresponds to the elastic potential energy that the substance renders at particular states of matter of equilibrium vapor pressure, as determined by the substance's phase change characteristics.

### (5) Surrounding Temperature

In the following descriptions and references, the Surrounding Temperature means:
(i) the current temperature of the outdoors, in the atmosphere, at any particular time of day or night, or the temperature found in water flow such as seas, lakes, rivers, sea beds, aquifers or groundwater sources, and
(ii) the room temperature indoors (often called “room temperature”) including but not limited to:
   the temperature inside a building or structure such as in an office building, apartment complex or house, which may or may not be temperature controlled;
   the temperature inside a manufacturing or industrial facility, including where the temperature is hotter because of the heat generated from operations such as a foundry, manufacturing, pulp & paper, textiles, commercial kitchens & bakeries, or laundries and dry cleaning;
   the temperature at certain depths in mine shafts with or without active mining operations;
   the temperature in a greenhouse, shed or other complex specifically built to house equipment.

### (6) ISMC=ISO 13443:

International Standard Metric Conditions of temperature, pressure and humidity (state of saturation), used for measurements and calculations carried out on natural gases, natural-gas substitutes and similar fluids in the gaseous state, are 288.15 K (15° C.) and 101.325 kPa (1 Atm).

### (7) Vaporization

Vaporization of an element or compound is a phase transition from the liquid phase to gas phase. There are two types of vaporization: evaporation and boiling. However, in the Pressure Power System, mainly evaporation is considered as the phase transition from the liquid phase to gas phase that occurs at temperatures below the boiling temperature at a given pressure. Evaporation usually occurs on the surface.

### (8) Free Expansion

Free expansion is the process which causes a pressurized gas to expand into an insulated evacuation chamber at about atmospheric pressure. The fluid thereby experiences a natural cooling, which causes its temperature to decrease to a little above the dew point of the substance.

During free expansion, no work is done by the vapor, making the process almost isentropic. The vapor goes through states of no thermodynamic equilibrium before reaching its final state, which implies that one cannot define thermodynamic parameters as values of the vapor as a whole.

For example, the pressure changes locally from point to point, and the volume occupied by the vapor, which is formed of particles, is not a well defined quantity but directly reflects the state function of the surrounding system, here throughout the Vapor Recovery Unit of the cold sub-system.

### (9) Bubbling Condensation

Bubbling Condensation occurs when a condensable fluid, in vapor phase, is injected in a “bubble-column vapor mixture condenser”, when used as a pressure vessel already partially filled with a bath of the same substance, in liquid phase.

The vapor is poured into the liquid directly, at the bottom of the column, which causes the vapor to form bubbles which adjust their temperature/pressure equilibrium to the Ambient Temperature and Ambient Pressure of the bath and make the vapor to mix completely with the liquid, by direct contact condensation.

### (10) Phases

In bulk, matter can exist in several different forms, or states of aggregation, known as phases, depending on Ambient Pressure, temperature and volume. A phase is a form of matter that has a relatively uniform chemical composition and physical properties (such as density, specific heat, refractive index, pressure and so forth) which, in a particular system, determine its state function.

Phases are sometimes called states of matter, but this term can lead to confusion with thermodynamic states. For example, two gases maintained at different pressures are in different thermodynamic states (different pressures), but in the same phase (both are gases). The state or phase of a given set of matter can change depending on Ambient Pressure and Ambient Temperature conditions as determined by their specific conditions of state function, transitioning to other phases as these conditions change to favor their existence. For example, liquid transitions to gas with an increase in temperature.

### (11) State of Matter

States of matter are the distinct forms that different phases of matter take on. Solid, liquid and gas are the most common states of matter.

States of matter also may be defined in terms of phase transitions. A phase transition indicates a change in structure and can be recognized by an abrupt change in properties. By this definition, a distinct state of matter is any set of states distinguished from any other set of states by a phase transition.

The state or phase of a given set of matter can change depending on the state function of the system (Ambient Pressure and Ambient Temperature conditions), transitioning to other phases as these conditions change to favor their existence; for example, liquid transitions to gas and reverse with an increase/decrease in Ambient Temperature or Ambient Pressure.

Distinctions between states are based on differences in molecular interrelationships: liquid is the state in which intermolecular attractions keep molecules in proximity, but do not keep the molecules in fixed relationships, which is able to conform to the shape of its container but retains a (nearly) constant volume independent of pressure; gas is that state in which the molecules are comparatively separated and intermolecular attractions have relatively little effect on their respective motions, which has no definite shape or volume, but occupies the entire pressure device in which it is confined by reducing/increasing its Ambient Pressure/Temperature.

### (12) Volatility

The Working Fluid's state of matter is mainly determined by the tendency of the substance to vaporize, known as its volatility, and is related directly to the substance's equilibrium vapor pressure.

At a given temperature, the state function of the system determines the equilibrium vapor pressure of a fluid or compound substance stored in a determined volume, at which its gaseous phase (“vapor”) is in equilibrium with its liquid phase.

### (13) Expansion Factor

The volatility of the Working Fluid results in a significant augmentation in volume, ranging from approximately 200 to 400 times to much higher depending on the substance chosen for the Working Fluid, the normal volume of its liquid form.

Examples (at ISCM conditions):
for R-410A the expansion factor is about 256 times,
for Propane the expansion factor is about 311 times, and
for Carbon Dioxide the expansion factor is about 845 times.

Within each sub-system of the Pressure Power Unit, because the equilibrium vapor pressure of the Working Fluid depends on said expansion factor, which does not vary linearly with the temperature, the state function W=PV (pressure multiplied by volume) must also consider the related Ambient Temperature.

Therefore, the choice of the substance is primordial and must be made accordingly to the working conditions of Ambient Temperature which may be maintained in the cold and warm sub-systems. As examples, most of the references made in this document are generally based on the use of R-410A as the Working Fluid and figure models where the surrounding temperatures of the warm sub-system vary so that it enables maintaining the Ambient Temperature within the warm sub-system around the ISMC and where the cold sub-system is maintained at Ambient Temperatures between −40° C. (−40° F.) and −30° C. (−22° F.).

### (14) Vapor/Liquid Equilibrium

The property of vapor pressure or equilibrium vapor pressure of a substance represents the pressure exerted by a vapor in thermodynamic equilibrium with its condensed phase at a given temperature in a closed system, per se when a Working Fluid is stored in a container, the capacity of which is larger than the liquid fluid volume equivalent but smaller than the vapor pressure volume equivalent, at the particular conditions of Temperature/Pressure met in the sub-system. Consequently, in the container the Working Fluid naturally vaporizes/condenses until “saturated” at its Vapor/Liquid Equilibrium.

### (15) Normal State Function

In a Pressure Power Unit, the reference value is the Normal Boiling Point of the Working Fluid which should represent closely the normal state function within the cold sub-system. Thus, the fluid must be chosen according to the exploitation criteria of the cold sub-system: it is the Ambient Temperature in the cold sub-system which determines the nature of the substance to be selected, for the state function to be as close as possible to the Working Fluid's N.B.P.

Examples
the N.B.P. of R23/Fluoryl corresponds to a temperature of −82.1° C./−115.78 K,
the N.B.P. of the refrigerant R-410A corresponds to a temperature of −52.2° C./−61.96° F.,
the N.B.P. of R134A corresponds to a temperature of −26.3° C./−15.34° F.

### (16) Critical Point

However, when choosing the substance one must also refer to its “Critical Point”. Each possible Working Fluid shows a specific state of saturation at a certain boiling point corresponding to a precise critical point of its phase transition at which the liquid/gas phase boundary ceases to exist and the substance is present only in its gaseous form, which limits the maximum temperature/pressure that needs to be attained by the state function of the warm sub-system, per se an Ambient Pressure generally ranging between 32 and 64 bars, and corresponds to the maximum level of Ambient Temperature to maintain in said warm sub-system, as determined by the Temperature/Pressure chart of the Working Fluid's material.

Examples
the Critical Point of R23/Fluoryl corresponds to a pressure of 48.37 bars (701.55 psi) at 25.6° C./78° F.,
the Critical Point of the refrigerant R-410A corresponds to a pressure of 49.4 bars (716.49 psi) at a temperature of 72.5° C./162.5° F.,
the Critical Point of R134A corresponds to a pressure of 40.6 bars (588.85 psi) at 100.9° C./213.6° F.).

### (17) Examples of Working Fluids (Pressures/Temperatures Chart)

| Temp | Pressure kPa (100 kPa = 1 bar = 14.51 psi) | | | | | | | | | | |
|---|---|---|---|---|---|---|---|---|---|---|---|
| ° C. | Fluoryl | R134a | R413A | Propane | R407C | R410A | R417A | R404A | R507 | R408A | R403B |
| −48 | 425 | | | | | 21 | | | | | 12 |
| −46 | 461 | | | | | 33 | | | 7 | | 24 |
| −44 | 512 | | | | | 46 | | 4 | 17 | 1 | 35 |
| −42 | 552 | | | 1 | | 61 | 7 | 15 | 28 | 11 | 47 |
| −40 | 609 | | | 11 | 86 | 76 | 16 | 26 | 40 | 22 | 60 |
| −38 | 669 | | | 22 | 95 | 93 | 26 | 39 | 53 | 34 | 73 |
| −36 | 717 | | | 32 | 105 | 111 | 37 | 52 | 67 | 46 | 88 |
| −34 | 784 | | 4 | 44 | 116 | 130 | 49 | 66 | 82 | 60 | 104 |
| −32 | 837 | | 14 | 55 | 127 | 150 | 61 | 81 | 98 | 74 | 118 |
| −30 | 911 | | 24 | 68 | 139 | 172 | 74 | 97 | 114 | 89 | 138 |
| −28 | 990 | | 34 | 81 | 152 | 195 | 88 | 114 | 132 | 105 | 157 |
| −26 | 1051 | 3 | 45 | 96 | 167 | 219 | 103 | 133 | 151 | 123 | 178 |
| −24 | 1137 | 14 | 57 | 111 | 182 | 245 | 119 | 152 | 171 | 141 | 199 |
| −22 | 1205 | 26 | 70 | 128 | 198 | 273 | 135 | 173 | 193 | 161 | 220 |
| −20 | 1300 | 39 | 84 | 144 | 215 | 303 | 153 | 195 | 216 | 181 | 243 |
| −18 | 1399 | 49 | 98 | 163 | 234 | 334 | 171 | 219 | 240 | 203 | 267 |
| −16 | 1477 | 59 | 114 | 182 | 253 | 367 | 191 | 243 | 265 | 227 | 295 |
| −14 | 1586 | 72 | 130 | 203 | 274 | 402 | 211 | 270 | 292 | 251 | 320 |
| −12 | 1671 | 86 | 147 | 223 | 297 | 438 | 233 | 297 | 320 | 277 | 348 |
| −10 | 1789 | 101 | 165 | 246 | 320 | 477 | 256 | 326 | 350 | 305 | 382 |
| −8 | 1913 | 118 | 184 | 269 | 345 | 518 | 280 | 357 | 382 | 334 | 412 |
| −6 | 2011 | 135 | 204 | 294 | 372 | 561 | 305 | 390 | 415 | 364 | 446 |
| −4 | 2146 | 153 | 226 | 319 | 400 | 607 | 332 | 424 | 450 | 396 | 483 |
| −2 | 2251 | 172 | 248 | 347 | 430 | 654 | 360 | 460 | 486 | 430 | 520 |
| 0 | 2398 | 192 | 272 | 374 | 461 | 704 | 389 | 498 | 525 | 465 | 560 |
| 2 | 2552 | 211 | 297 | 405 | 494 | 757 | 420 | 537 | 565 | 502 | 603 |
| 4 | 2672 | 229 | 323 | 435 | 529 | 812 | 452 | 579 | 608 | 541 | 644 |
| 6 | 2839 | 253 | 350 | 468 | 566 | 869 | 485 | 623 | 652 | 582 | 689 |
| 8 | 2969 | 283 | 379 | 501 | 604 | 930 | 520 | 669 | 698 | 625 | 732 |
| 10 | 3150 | 313 | 409 | 537 | 645 | 993 | 557 | 716 | 747 | 670 | 783 |
| 12 | 3340 | 342 | 441 | 573 | 688 | 1059 | 595 | 766 | 798 | 716 | 831 |
| 14 | 3489 | 372 | 474 | 612 | 732 | 1128 | 635 | 819 | 851 | 765 | 886 |
| 16 | 3695 | 403 | 508 | 651 | 779 | 1200 | 676 | 873 | 906 | 816 | 942 |
| 18 | 3856 | 436 | 544 | 694 | 828 | 1275 | 719 | 929 | 964 | 869 | 998 |
| 20 | 4081 | 469 | 582 | 736 | 880 | 1353 | 764 | 989 | 1024 | 920 | 1057 |

What is claimed is:

1-67. (canceled)

68. A Pressure Power Unit comprising:
a Vapor Recovery Unit/cold sub-system and a Heat Recovery Unit/warm sub-system arranged in a closed loop, the output of the cold sub-system being fed to the input of the warm sub-system and the output of the warm sub-system being fed to the input of the cold sub-system;
a Work Extractor Unit positioned between the outlet of said warm sub-system and the inlet of said cold sub-system, operable to convert said elastic potential energy/pressure differential into kinetic energy;
said cold sub-system and warm sub-system being respectively maintained at lower and higher temperatures relative to one another;
a hydraulic pump positioned between the outlet of said cold sub-system and the inlet of said warm sub-system, operable to circulate the Working Fluid and maintain the volume of liquid part constant in both cold and warm sub-systems; and
a Working Fluid circulating in said closed loop, said Working Fluid having different equilibrium vapor pressures in said cold sub-system and in said warm sub-system, according to the respective state function resulting from the Ambient Temperature maintained in both sub-systems and representing two different levels of elastic potential energy which results in a pressure differential between said cold sub-system and said warm sub-system.

69. The Pressure Power Unit of claim 68 wherein the Vapor Recovery Unit comprises:
an Expansion Chamber;
a Vacuum Pump;
a Condenser; and
an external cooling system.

70. The Pressure Power Unit of claim 68 wherein the Heat Recovery Unit comprises:
a Vaporizer;
Ambient Heat Collectors; and
optionally, a Pre-Heater.

71. The Pressure Power Unit of claim 68, wherein the Work Extractor Unit comprises:
a Hydropneumatic Engine, comprised of
a Gas Distributor;
a series of Hydropneumatic Cylinders; and
a Hydraulic Rectifier; and
a hydraulic motor.

72. The Pressure Power Unit of claim 68, wherein said Working Fluid is stored at a warmer temperature in the warm sub-system than in the cold sub-system, the equilibrium vapor pressure of the Working Fluid in the warm sub-system versus the equilibrium vapor pressure of the Working Fluid in the cold sub-system causing an exploitable pressure differential enabling extraction of work.

73. The Pressure Power Unit of claim 69 wherein the Expansion Chamber comprises a pressure vessel enlarging the volumetric efficiency of said cold sub-system 100, thereby enabling the free expansion of the Working Fluid in its gaseous form to about atmospheric pressure and thereby its N.B.P.

74. The Pressure Power Unit of claim 68, wherein said Working Fluid is stored at a temperature close to and above its NBP in the cold sub-system.

75. The Pressure Power Unit of claim 69 wherein the external cooling system helps to maintain the Ambient Temperature of said cold sub-system close to the Working Fluid's NBP.

76. The Pressure Power Unit of claim 75, wherein said heat recovery unit is warmed by energy sources selected from the group consisting of: thermal solar; geothermal; wind; biomass; fuel cells; water flows such as rivers, sea beds, aquifers or groundwater sources; heat gradient found underground, for example, in mine shafts and in the basements of buildings; commercial or industrial heat recovery systems; greenhouses; and ambient temperature found in the atmosphere immediately surrounding or remote, or in industrial buildings.

77. The Pressure Power Unit of claim 68, wherein said Working Fluid is selected from the group consisting of: an organic material, a compound, a blend of compounds, refrigerants, ammonia, sulfur dioxide, non-halogenated hydrocarbons such as fluoryl, propane, and methane, chemical elements like nitrogen and compounds such as carbon dioxide and nitrous oxide.

78. The Pressure Power Unit of claim 68, wherein the state functions of both the cold sub-system and the warm sub-system are maintained constant to make the volatility of the Working Fluid stay at the respective vapor/liquid equilibrium, at which the gaseous phase (“vapor”) is in equilibrium with its liquid phase, so that it only partially fills said pressure vessels in the liquid state of matter, the rest of each vessel being filled with the Working Fluid in a pressurized gaseous state.

79. The Pressure Power Unit of claim 68, wherein said Working Fluid has a Normal Boiling Point (NBP) notably below the ‘ISMC’ temperature (International Standard Metric Conditions of temperature, pressure and humidity or state of saturation: 288,15° K [15° C.] and 101,325 kPa [1 Atm]).

80. A Pressure Power Unit comprising:
a condenser and a vaporizer arranged in a closed loop, the output of the condenser being fed to the input of the vaporizer and the output of the vaporizer being fed to the input of the condenser;
said condenser and vaporizer being respectively maintained at lower and higher temperatures relative to one another;
a Working Fluid circulating in said closed loop, said Working Fluid having different equilibrium vapor pressures in said condenser and in said vaporizer, according to the respective state function, representing two different levels of elastic potential energy which results in a pressure differential between said condenser and said vaporizer; and
a work extraction system positioned between the outlet of said vaporizer and the inlet of said condenser, operable to convert said elastic potential energy/pressure differential into kinetic energy.

81. The Pressure Power Unit of claim 80, wherein said Working Fluid is stored at a warmer temperature in the vaporizer than in the condenser, the equilibrium vapor pressure of the Working Fluid in the vaporizer versus the equilibrium vapor pressure of the Working Fluid in the condenser causing an exploitable pressure differential enabling extraction of work.

82. The Pressure Power Unit of claim 80, wherein said condenser comprises an expansion chamber enabling free expansion of the Working Fluid in its gaseous form to about atmospheric pressure.

83. The Pressure Power Unit of claim 80, wherein part of the gaseous Working Fluid liquefies in the condenser, enabling said Working Fluid to keep constant its vapor/liquid equilibrium at an Ambient Temperature a little above its NBP.

84. The Pressure Power Unit of claim 80, wherein said Working Fluid is stored at a temperature close to and above its NBP in the condenser.

85. The Pressure Power Unit of claim 79, wherein the state functions of both the condenser and the vaporizer are maintained constant to make the volatility of the Working Fluid stay at the respective vapor/liquid equilibrium, at which the gaseous phase (“vapor”) is in equilibrium with its liquid phase, so that it only partially fills said pressure vessels in the liquid state of matter, the rest of each vessel being filled with the Working Fluid in a pressurized gaseous state.

86. The Pressure Power Unit of claim 80, further comprising a heat collector to collect heat energy to maintain the temperature of the vaporizer.

87. The Pressure Power Unit of claim 86, wherein said heat collector is warmed by energy sources selected from the group consisting of: thermal solar; geothermal; wind; fuel cells; biomass; water flows such as rivers, sea beds, aquifers or groundwater sources; heat gradient found underground, for example, in mine shafts and in the basements of buildings; commercial or industrial heat recovery systems; greenhouses; and ambient temperature found in the atmosphere not immediately surrounding or in industrial buildings.

88. The Pressure Power Unit of claim 80, wherein said Working Fluid is selected from the group consisting of: an organic material, a compound, a blend of compounds, refrigerants, ammonia, sulfur dioxide, non-halogenated hydrocarbons such as fluoryl, propane, and methane, chemical elements like nitrogen and compounds such as nitrous oxide.

89. The Pressure Power Unit of claim 80, wherein said Working Fluid has a Normal Boiling Point (NBP) below the ‘ISMC’ temperature (International Standard Metric Conditions of temperature, pressure and humidity or state of saturation: 288,15° K [15° C.] and 101,325 kPa [1 Atm]).

90. The Pressure Power Unit of claim 80 wherein the Work Extraction System comprises a Hydraulic Motor, actuated by said secondary high pressurized fluid flow, for transforming linear kinetic energy into rotary kinetic energy, and converting pressure head to useful mechanical energy.

91. The Pressure Power Unit of claim 80 wherein the condenser is surrounded by an external cooling system which helps maintaining the Ambient Temperature of said cold sub-system close to the Working Fluid's NBP.
